(19) United States
(12) Patent Application Publication
(10) Pub. No.: US 2026/0352098 A1
(43) Pub. Date: Nov. 5, 2026

(54) SWITCHING POWER SUPPLY SYSTEM MODULE

(71) Applicant: Murata Manufacturing Co., Ltd., Kyoto-fu (JP)

(72) Inventor: Tatsuya HOSOTANI, Nagaokakyo-shi (JP)

(73) Assignee: Murata Manufacturing Co., Ltd., Kyoto-fu (JP)

(21) Appl. No.: 19/706,947

(22) Filed: Jun. 12, 2026

Related U.S. Application Data
(63) Continuation of application No. PCT/JP2024/037720, filed on Oct. 23, 2024.

(30) Foreign Application Priority Data
Dec. 22, 2023 (JP) 2023-216616

(51) Int. Cl. H02M 3/00; H01F 3/10; H01F 27/29; H01F 27/32; H02M 3/158

(52) U.S. Cl. CPC H02M 3/003; H01F 3/10; H01F 27/29; H01F 27/324; H02M 3/158

(57) ABSTRACT

A switching power supply system module includes power conversion circuits, each including a switching element and an inductor; an input capacitor; and an output capacitor. The inductors included in the power conversion circuits form an array inductor integrally molded using multiple inductor conductors and a magnetic core. The magnetic core includes first and second magnetic portions, each composed of a different type of magnetic material. The first magnetic portion is in close contact with and encloses the inductor conductors. The second magnetic portion is integrated with the first magnetic portion without contacting the inductor conductors. The inductor conductors are adjacent to each other with portions of the first magnetic portion sandwiched therebetween. The inductor conductors include main conductors electrically connected to a common output capacitor and terminal portions connected to end portions of the main conductors outside the magnetic core and electrically connected to multiple switching elements.

### CROSS-REFERENCE TO RELATED APPLICATIONS

This application claims benefit of priority to International Patent Application No. PCT/JP2024/037720, filed Oct. 23, 2024, and to Japanese Patent Application No. 2023-216616, filed Dec. 22, 2023, the entire contents of each are incorporated herein by reference.

### BACKGROUND

### Technical Field

The present disclosure relates to a switching power supply system module including an array inductor.

### Background Art

Integrated power supply systems including a plurality of power conversion circuits have been developed as power supply systems for supplying large currents. By incorporating a plurality of power conversion circuits, the current handled by each power conversion circuit can be reduced, thereby reducing Joule loss. This results in high efficiency and heat dispersion.

In addition, by operating a plurality of power conversion circuits in multiphase operation, integrated power supply systems can be operated at higher frequencies, and smoothing circuits can be reduced in size, thereby achieving a reduction in the size of the power supply system. Furthermore, in order to handle larger currents, scalable power supply systems that are capable of flexibly changing the number of power conversion circuits that are used in order to control the power in accordance with the magnitude of the output current are becoming important.

Each of the plurality of power conversion circuits includes an inductor, and the integrated power supply system includes a plurality of inductors.

Examples of configurations employing a plurality of inductors include those described in International Publication No. 2020/035968, Japanese Unexamined Patent Application Publication No. 2021-180199 and U.S. Patent Application No. 2013/0113596.

### SUMMARY

However, in configurations of the related art such as those described in International Publication No. 2020/035968, Japanese Unexamined Patent Application Publication No. 2021-180199 and U.S. Patent Application No. 2013/0113596, if there is even a small space between an inductor conductor and a magnetic core, the magnetic flux generated by the current flowing through the inductor conductor cannot be utilized to fullest extent. Furthermore, when leakage magnetic flux is generated, unwanted radiation of electromagnetic noise occurs, causing problems such as malfunctions in a power conversion circuit.

Accordingly, the present disclosure provides a switching power supply system module including an array inductor that can realize a physical structure that is scalable according to the magnitude of an output current, can make the most effective use of the magnetic flux generated by a current flowing through an inductor conductor, and can suppress the occurrence of leakage magnetic flux.

A switching power supply system module according to an embodiment of the present disclosure includes a plurality of power conversion circuits, an input capacitor, and an output capacitor. Each power conversion circuit includes a switching element and an inductor. The plurality of inductors included in the multiple power conversion circuits form an array inductor molded in an integrated manner using a plurality of inductor conductors and a magnetic core. The magnetic core includes a first magnetic portion and a second magnetic portion, each composed of a different type of magnetic material. The first magnetic portion is in close contact with and encloses the plurality of inductor conductors. The second magnetic portion is integrated with the first magnetic portion without contacting the plurality of inductor conductors. The plurality of inductor conductors are disposed adjacent to each other with portions of the first magnetic portion interposed therebetween and include main conductors electrically connected to the output capacitor, which is a common output capacitor, and terminal portions connected to end portions of the main conductors outside the magnetic core and electrically connected to the plurality of switching elements. The switching power supply system module forms a multi-phase converter using the plurality of power conversion circuits including the array inductor.

According to the present disclosure, it is possible to realize a physical structure that is scalable according to the magnitude of an output current, to make the most effective use of magnetic flux generated by a current flowing through an inductor conductor, and to suppress the occurrence of leakage magnetic flux.

### BRIEF DESCRIPTION OF THE DRAWINGS

FIG. 1 is an equivalent circuit diagram of a switching power supply system module according to a First Embodiment of the present disclosure;

FIGS. 2A and 2B are external perspective views of an array inductor according to the First Embodiment of the present disclosure;

FIG. 3A is a plan view of the array inductor according to the First Embodiment of the present disclosure, and FIG. 3B is a side view of the array inductor;

FIG. 4 is a diagram illustrating a current flowing in the array inductor according to the First Embodiment of the present disclosure and a portion of the magnetic flux generated;

FIG. 5 is an external perspective view of an array inductor according to a Second Embodiment of the present disclosure;

FIG. 6A is a plan view of the array inductor according to the Second Embodiment of the present disclosure, and FIG. 6B is a side view of the array inductor;

FIG. 7 is a diagram illustrating the current flowing in the array inductor according to a Second Embodiment of the present disclosure and a portion of the magnetic flux generated;

FIG. 8 is an external perspective view of an array inductor according to a Third Embodiment of the present disclosure;

FIG. 9 is an external perspective view of an array inductor according to a Fourth Embodiment of the present disclosure;

FIG. 10 is an exploded perspective view of a switching power supply system module according to the Fourth Embodiment of the present disclosure; and

FIGS. 11A, 11B, and 11C are external perspective views of array inductors that include different numbers of main conductors (inductors).

### DETAILED DESCRIPTION

### First Embodiment

A switching power supply system module according to a First Embodiment of the present disclosure will be described with reference to the drawings.

### Switching Power Supply System Module 90

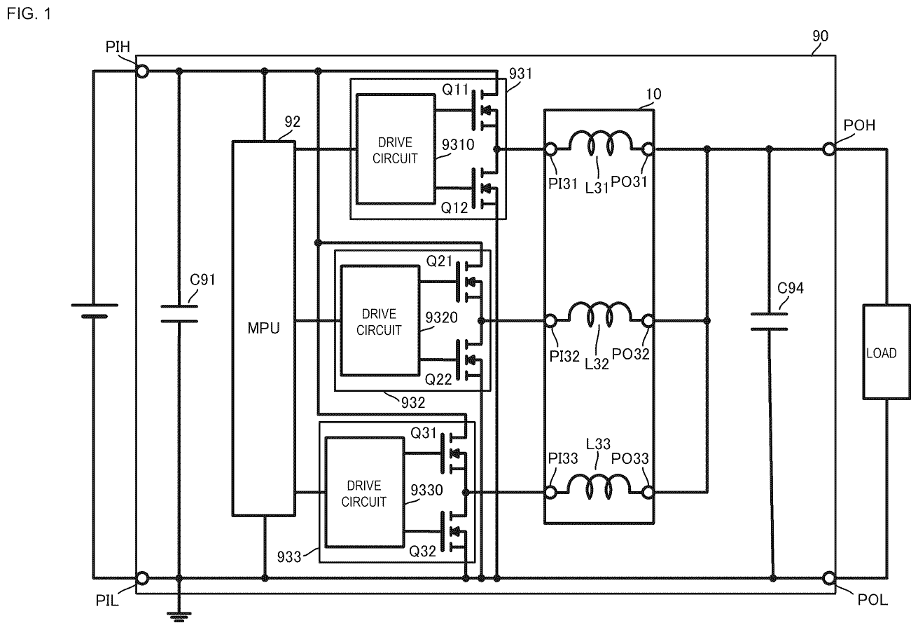

FIG. 1 is an equivalent circuit diagram of a switching power supply system module according to the First Embodiment of the present disclosure. As illustrated in FIG. 1, a switching power supply system module 90 includes an input capacitor C91, an MPU 92, a plurality of power semiconductor ICs 931 to 933 (power semiconductor IC 931, power semiconductor IC 932, and power semiconductor IC 933), an array inductor 10, and an output capacitor C94.

The power semiconductor IC 931 includes a drive circuit 9310, a switching element Q11, and a switching element Q12. The power semiconductor IC 932 includes a drive circuit 9320, a switching element Q21, and a switching element Q22. The power semiconductor IC 933 includes a drive circuit 9330, a switching element Q31, and a switching element Q32. The switching element Q11, the switching element Q12, the switching element Q21, the switching element Q22, the switching element Q31, and the switching element Q32 are power semiconductor elements, such as power MOSFETs.

The array inductor 10 includes an inductor L31, an inductor L32, and an inductor L33. The inductor L31 has a terminal PI31 and a terminal PO31. The inductor L32 has a terminal PI32 and a terminal PO32. The inductor L33 has a terminal PI33 and a terminal PO33.

The power semiconductor IC 931 and the inductor L31 form a first power conversion circuit. The power semiconductor IC 932 and the inductor L32 form a second power conversion circuit. The power semiconductor IC 933 and the inductor L33 form a third power conversion circuit.

The switching power supply system module 90 has a pair of input terminals PIH and PIL, and a pair of output terminals POH and POL.

The positive electrode of a DC power supply is connected to the input terminal PIH. The negative electrode of the DC power supply is connected to the input terminal PIL. The input terminal PIL is connected to a reference potential. In other words, the input terminal PIL is electrically grounded.

The input capacitor C91 is connected between the input terminals PIH and PIL. The input terminals PIH and PIL are connected to the MPU 92, so that the MPU 92 receives power from the DC power supply and operates.

The drain terminal of the switching element Q11 of the power semiconductor IC 931 is connected to the input terminal PIH. The source terminal of the switching element Q11 is connected to the drain terminal of the switching element Q12. The source terminal of the switching element Q12 is connected to the input terminal PIL.

An input terminal of the drive circuit 9310 is connected to the MPU 92, and output terminals of the drive circuit 9310 are connected to the gate terminal of the switching element Q11 and the gate terminal of the switching element Q12.

The drain terminal of the switching element Q21 of the power semiconductor IC 932 is connected to the input terminal PIH. The source terminal of the switching element Q21 is connected to the drain terminal of switching element Q22. The source terminal of the switching element Q22 is connected to the input terminal PIL.

An input terminal of the drive circuit 9320 is connected to the MPU 92, and output terminals of the drive circuit 9320 are connected to the gate terminal of the switching element Q21 and the gate terminal of the switching element Q22.

The drain terminal of the switching element Q31 of the power semiconductor IC 933 is connected to input terminal PIH. The source terminal of the switching element Q31 is connected to the drain terminal of the switching element Q32. The source terminal of the switching element Q32 is connected to the input terminal PIL.

An input terminal of the drive circuit 9330 is connected to the MPU 92, and output terminals of the drive circuit 9330 are connected to the gate terminal of the switching element Q31 and the gate terminal of the switching element Q32.

A node between the source terminal of the switching element Q11 and the drain terminal of the switching element Q12 is connected to the terminal PI31 of the inductor L31 of the array inductor 10.

A node between the source terminal of the switching element Q21 and the drain terminal of the switching element Q22 is connected to a terminal PI32 of the inductor L32 of the array inductor 10.

A node between the source terminal of the switching element Q31 and the drain terminal of the switching element Q32 is connected to the terminal PI33 of the inductor L33 of the array inductor 10.

The terminal PO31 of the inductor L31, the terminal PO32 of the inductor L32, and the terminal PO33 of the inductor L33 of the array inductor 10 are connected to each other and connected to the output terminal POH.

The output capacitor C94 is connected between the output terminal POH and the output terminal POL. The output terminal POL is connected to the input terminal PIL.

A load to which the switching power supply system module 90 supplies power is connected to the output terminals POH and POL.

In this configuration, the MPU 92 outputs control signals to the plurality of power semiconductor ICs 931 to 933 in order to carry out switching control with a predetermined phase difference (in this case, a 120° phase difference). The plurality of power semiconductor ICs 931 to 933 perform switching control based on these control signals. Thus, the switching power supply system module 90 forms a multi-phase converter with the first power conversion circuit consisting of the power semiconductor IC 931 and the inductor L31, the second power conversion circuit consisting of the power semiconductor IC 932 and the inductor L32, and the third power conversion circuit consisting of the power semiconductor IC 933 and the inductor L33.

In the above description, a multi-phase converter having three components (three power conversion circuits) is used as an example, but the number of components is not limited to three, and the switching power supply system module 90 can be configured with any number of components in accordance the specification in order to realize a scalable physical structure.

### Array Inductor 10

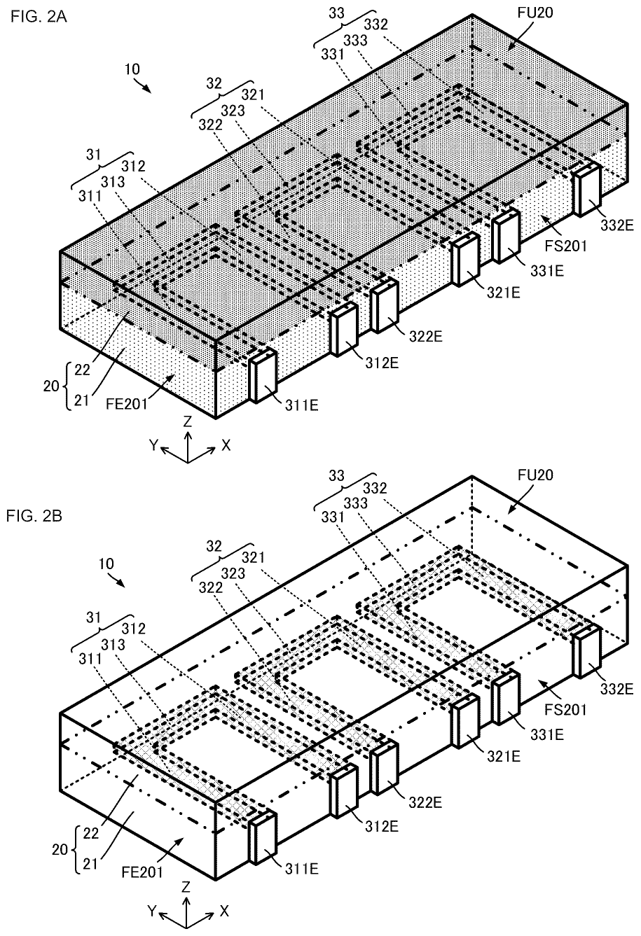

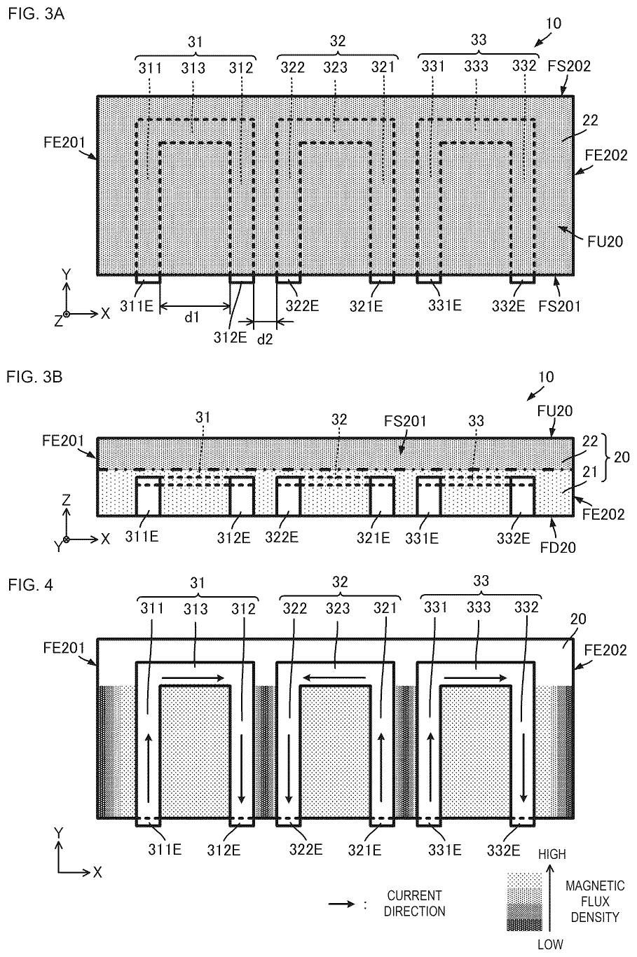

FIGS. 2A and 2B are external perspective views of an array inductor according to a First Embodiment of the present disclosure. FIG. 2A is a diagram illustrating the configuration of a magnetic core in an easy-to-understand manner, and FIG. 2B is a diagram illustrating the configuration of inductor conductors in an easy-to-understand manner. FIG. 3A is a plan view of the array inductor according to the First Embodiment of the present disclosure, and FIG. 3B is a side view of the array inductor. In each diagram illustrating the embodiments of the present disclosure, the three orthogonal axes are referred to as the X-axis, Y-axis, and Z-axis. However, these are names of axes used for ease of explanation and do not limit, for example, the direction in which the array inductor 10 is used. The X-axis direction corresponds to a “first direction” of the present disclosure, and the Z-axis direction corresponds to a “second direction” of the present disclosure.

As illustrated in FIGS. 2A, 2B, 3A, and 3B, the array inductor 10 includes a magnetic core 20, a plurality of main conductors 31 to 33 (main conductor 31, main conductor 32, and main conductor 33), a terminal portion 311E, a terminal portion 312E, a terminal portion 321E, a terminal portion 322E, a terminal portion 331E, and a terminal portion 332E.

The main conductor 31, the terminal portion 311E, and the terminal portion 312E form the first inductor L31. The main conductor 32, the terminal portion 321E, and the terminal portion 322E form the second inductor L32. The main conductor 33, the terminal portion 331E, and the terminal portion 332E form the third inductor L33.

### Magnetic Core 20

The magnetic core 20 has a substantially rectangular parallelepiped shape with surfaces parallel to the X-axis, Y-axis, and Z-axis directions (three orthogonal axes). The magnetic core 20 has a first surface FD20 and a second surface FU20 that are perpendicular to the Z-axis direction. The magnetic core 20 has a third surface FE201 and a fourth surface FE202 that are perpendicular to the X-axis direction. The magnetic core 20 has a fifth surface FS201 and a sixth surface FS202 that are perpendicular to the Y-axis direction. The fifth surface FS201 corresponds to a “first side surface” of the present disclosure, and the sixth surface FS202 corresponds to a “second side surface” of the present disclosure.

The magnetic core 20 includes a first magnetic portion 21 and a second magnetic portion 22. The first magnetic portion 21 and the second magnetic portion 22 are disposed next to each other in the Z-axis direction and molded so as to be integrated with each other. The first magnetic portion 21 is the part on the first surface FD20 side, and the second magnetic portion 22 is the part on the second surface FU20 side.

The first magnetic portion 21 and the second magnetic portion 22 are composed of different types of magnetic materials. More specifically, the first magnetic portion 21 and the second magnetic portion 22 are composed of a metal alloy magnetic material. The magnetic material that constitutes the metal alloy magnetic material is a metal magnetic material.

The first magnetic portion 21 and the second magnetic portion 22 are formed by pulverizing a magnetic material, covering the surfaces of the pulverized material with an insulating film, and mixing a binder with the resulting material. In this case, the first magnetic portion 21 and the second magnetic portion 22 are composed of different components. This allows the first magnetic portion 21 and the second magnetic portion 22 to have different physical properties and relative permeabilities.

More specifically, a relative magnetic permeability εr1 of the first magnetic portion 21 is smaller than a relative magnetic permeability εr2 of the second magnetic portion 22 (εr1<εr2). Furthermore, the first magnetic portion 21 has higher adhesion to metal than the second magnetic portion 22.

### First Inductor L31

The main conductor 31, the terminal portion 311E, and the terminal portion 312E form a first inductor conductor, and the main conductor 31 is covered with the magnetic core 20 to form the first inductor L31.

The main conductor 31 consists of a straight conductor 311, a straight conductor 312, and a straight conductor 313. The straight conductors 311, 312, and 313 consist of line-shaped conductors or strip-shaped conductors having a predetermined width.

The straight conductors 311 and 312 are disposed parallel to the Y-axis direction and spaced apart from each other in the X-axis direction by a distance (a width d1 of the inner space). One end of each of the straight conductors 311 and 312 in the extension direction is exposed at the fifth surface FS201.

The straight conductor 313 is disposed parallel to the X-axis direction. The straight conductor 313 connects the other end of the straight conductor 311 (the end closer to the sixth surface FS202) to the other end of the straight conductor 312 (the end closer to the sixth surface FS202). In this way, the main conductor 31 forms a wound winding conductor when viewed in the Z-axis direction.

The terminal portion 311E is connected to one end of the straight conductor 311. The terminal portion 311E consists of a line-shaped conductor or a strip-shaped conductor similar to the straight conductor 311. The terminal portion 311E is formed on the fifth surface FS201 of the magnetic core 20, and extends to a position that is substantially flush with the first surface FD20.

The terminal portion 312E is connected to one end of the straight conductor 312. The terminal portion 312E is composed of a line-shaped conductor or a strip-shaped conductor similar to the straight conductor 312. The terminal portion 312E is formed on the fifth surface FS201 of the magnetic core 20, and extends to a position that is substantially flush with the first surface FD20.

The terminal portion 311E is the first terminal PI31 illustrated in FIG. 1, and the terminal portion 312E is the second terminal PO31 illustrated in FIG. 1.

### Second Inductor L32

The main conductor 32, the terminal portion 321E, and the terminal portion 322E form a second inductor conductor, and the main conductor 32 is covered with the magnetic core 20 to form the second inductor L32.

The main conductor 32 consists of a straight conductor 321, a straight conductor 322, and a straight conductor 323. The straight conductors 321, 322, and 323 consist of line-shaped conductors or strip-shaped conductors having a predetermined width. The main conductor 32 has substantially the same shape as the main conductor 31.

The straight conductors 321 and 322 are disposed parallel to the Y-axis direction and are spaced apart from each other in the X-axis direction by a distance (the width d1 of the inner space). One end of each of the straight conductors 321 and 322 in the extension direction is exposed at the fifth surface FS201.

The straight conductor 323 is disposed parallel to the X-axis direction. The straight conductor 323 connects the other end (the end closer to the sixth surface FS202) of the straight conductor 321 to the other end (the end closer to the sixth surface FS202) of the straight conductor 322. As a result, the main conductor 32 forms a wound winding conductor when viewed in the Z-axis direction.

The terminal portion 321E is connected to one end of the straight conductor 321. The terminal portion 321E consists of a line-shaped conductor or a strip-shaped conductor similar to the straight conductor 321. The terminal portion 321E is formed on the fifth surface FS201 of the magnetic core 20, and extends to a position that is substantially flush with the first surface FD20.

The terminal portion 322E is connected to one end of the straight conductor 322. The terminal portion 322E consists of a line-shaped conductor or a strip-shaped conductor similar to the straight conductor 322. The terminal portion 322E is formed on the fifth surface FS201 of the magnetic core 20, and extends to a position that is substantially flush with the first surface FD20.

The terminal portion 321E is the first terminal PI32 illustrated in FIG. 1, and the terminal portion 322E is the second terminal PO32 illustrated in FIG. 1. The main conductor 32, the terminal portion 321E, and the terminal portion 322E form the second inductor conductor.

### Third Inductor L33

The main conductor 33, the terminal portion 331E, and the terminal portion 332E form a third inductor conductor, and the main conductor 33 is covered with the magnetic core 20 to form the third inductor L33.

The main conductor 33 consists of a straight conductor 331, a straight conductor 332, and a straight conductor 333. The straight conductors 331, 332, and 333 each consist of a line-shaped conductor or a strip-shaped conductor having a predetermined width. The main conductor 33 has substantially the same shape as the main conductors 31 and 32.

The straight conductors 331 and 332 are disposed parallel to the Y-axis direction and spaced apart in the X-axis direction by a distance (the width d1 of the inner space of the winding conductors). One end of each of the straight conductors 331 and 332 in the extension direction is exposed at the fifth surface FS201.

The straight conductor 333 is disposed parallel to the X-axis direction. The straight conductor 333 connects the other end (the end closer to the sixth surface FS202) of the straight conductor 331 to the other end (the end closer to the sixth surface FS202) of the straight conductor 332. As a result, the main conductor 33 forms a wound winding conductor when viewed in the Z-axis direction.

The terminal portion 331E is connected to one end of the straight conductor 331. The terminal portion 331E consists of a line-shaped conductor or a strip-shaped conductor similar to the straight conductor 331. The terminal portion 331E is formed on the fifth surface FS201 of the magnetic core 20, and extends to a position that is substantially flush with the first surface FD20.

The terminal portion 332E is connected to one end of the straight conductor 332. The terminal portion 332E consists of a line-shaped conductor or a strip-shaped conductor similar to the straight conductor 332. The terminal portion 332E is formed on the fifth surface FS201 of the magnetic core 20, and extends to a position that is substantially flush with the first surface FD20.

The terminal portion 331E is the first terminal PI33 illustrated in FIG. 1, and the terminal portion 332E is the second terminal PO33 illustrated in FIG. 1. The main conductor 33, the terminal portion 331E, and the terminal portion 332E form the third inductor conductor.

### Arrangement of Plurality of Inductors

The main conductor 31 of the first inductor L31, the main conductor 32 of the second inductor L32, and the main conductor 33 of the third inductor L33 are disposed inside the first magnetic portion 21 of the magnetic core 20. The positions of the main conductor 31, the main conductor 32, and the main conductor 33 in the Z direction are approximately the same.

The main conductor 31, the main conductor 32, and the main conductor 33 are disposed in that order from the fifth surface FS201 to the sixth surface FS202. In this case, in the main conductor 31, the straight conductor 311 is disposed closer to the fifth surface FS201 than the straight conductor 312. In the main conductor 32, the straight conductor 322 is disposed closer to the fifth surface FS201 than the straight conductor 321. In the main conductor 33, the straight conductor 331 is disposed closer to the fifth surface FS201 than the straight conductor 332.

With this configuration, the straight conductor 312 of the main conductor 31 and the straight conductor 322 of the main conductor 32 are disposed adjacent to each other in parallel at an adjacent distance d2. The straight conductor 321 of the main conductor 32 and the straight conductor 331 of the main conductor 33 are disposed adjacent to each other in parallel at the adjacent distance d2.

### Example of Manufacturing Method for Array Inductor 10

The array inductor 10 having such a configuration is formed as follows.

The materials for the first magnetic portion 21 and the second magnetic portion 22 are prepared from the above-mentioned materials.

The metal (for example, copper) that will be the material of the first inductor L31, the second inductor L32, and the third inductor L33 is prepared separately from the material of the first magnetic portion 21 and the material of the second magnetic portion 22, and then molded.

The main conductor 31, the main conductor 32, and the main conductor 33 are disposed inside the material of the first magnetic portion 21.

The material of the first magnetic portion 21 and the material of the second magnetic portion 22 are stacked one on top of the other and thermal molding is carried out.

As a result, the first magnetic portion 21 and the second magnetic portion 22 are integrally molded with the main conductor 31, the main conductor 32, and the main conductor 33 enclosed inside the first magnetic portion 21.

### Example of Effects of Using Array Inductor 10

As described above, the first magnetic portion 21 has a lower relative permeability than the second magnetic portion 22, but has higher adhesion to metal. Therefore, the array inductor 10 is configured such that the formation of gaps between the first magnetic portion 21 and the main conductors 31, 32, and 33 can be suppressed.

This increases the adhesion between the main conductor 31, the main conductor 32, and the main conductor 33 and the first magnetic portion 21. The array inductor 10 is able to increase the magnetic flux density of the magnetic flux generated by each of the main conductors 31, 32, and 33.

Furthermore, the second magnetic portion 22 has a higher relative permeability than the first magnetic portion 21. As a result, the array inductor 10 is able to suppress divergence of magnetic flux using the second magnetic portion 22. Therefore, the array inductor 10 can realized increased magnetic flux density. Although the second magnetic portion 22 has lower adhesion to metal than the first magnetic portion 21, this is not a disadvantage because the second magnetic portion 22 is not in direct contact with the main conductor 31, the main conductor 32, and the main conductor 33. Furthermore, the second magnetic portion 22 is integrally molded using the same type of material as the first magnetic portion 21. Therefore, the occurrence of voids at the interface between the second magnetic portion 22 and the first magnetic portion 21 is suppressed.

In this way, the array inductor 10 can achieve a high magnetic flux density and a large inductance despite having a small size.

Furthermore, by enclosing a plurality of winding conductors (main conductors) within the first magnetic portion 21 and further providing the second magnetic portion 22 having a higher relative permeability than the first magnetic portion 21 integrally with the first magnetic portion 21, the array inductor 10 can reduce leakage magnetic flux to the outside and suppress radiation (leakage) of electromagnetic noise into space.

Furthermore, the first magnetic portion 21 has a lower relative magnetic permeability than the second magnetic portion 22, but is adjacent to and in close contact with the inductor conductors, enabling a larger magnetic flux density to be generated due to the magnetic flux produced when a current flows through the inductor conductors during power conversion. On the other hand, the second magnetic portion 22 is farther from the inductor conductors than the first magnetic portion 21, but has a higher relative magnetic permeability than the first magnetic portion 21, enabling a greater magnetic flux density to be generated due to the magnetic flux produced when a current flows through the inductor conductors during power conversion. In this way, the first magnetic portion 21 and the second magnetic portion 22 can each generate a greater magnetic flux density, which makes the distribution of magnetic flux density in the magnetic core more uniform, and consequently reduced size, increased efficiency, and reduced noise can be simultaneously achieved for an integrated power supply system.

Furthermore, the magnetic structure of the array inductor 10 can be further optimized by adjusting the material of the first magnetic portion 21 and the material of the second magnetic portion 22. In other words, an optimal array inductor 10 can be configured depending on the specifications of the switching power supply system module 90 in which the array inductor 10 is to be used.

The switching power supply system module 90 achieves the following effects.

The array inductor 10 is small in size and can create a large inductance, and can therefore improve the efficiency of the switching power supply system module 90. Furthermore, the integrally molded structure makes it possible for heat to be uniformly distributed in the array inductor 10 and to suppress local increases in temperature, thereby improving the reliability of the switching power supply system module 90.

FIG. 4 is a diagram illustrating a current flowing in the array inductor according to the First Embodiment of the present disclosure and a portion of the magnetic flux generated.

As illustrated in FIG. 4, the terminal portions of the adjacent main conductors 31 and 32 on the output terminal side (terminal portions 312E and 322E) are adjacent to each other in the circuit. Furthermore, the terminal portions of the adjacent main conductors 32 and 33 on the input terminal side (terminal portions 321E and 331E) are adjacent to each other in the circuit.

As a result, a first current flowing in the winding conductor composed of the main conductor 31 and a second current flowing in the winding conductor composed of the main conductor 32 flow in opposite directions to each other in plan view. Furthermore, the second current flowing in the winding conductor composed of the main conductor 32 and a third current flowing in the winding conductor composed of the main conductor 33 flow in opposite directions to each other in plan view.

Therefore, the first current flowing through the straight conductor 312 of the main conductor 31 and the second current flowing through the straight conductor 322 of the main conductor 32, the straight conductor 312 and the straight conductor 322 being adjacent to each other, flow in the same direction. Furthermore, the second current flowing through the straight conductor 321 of the main conductor 32 and the third current flowing through the straight conductor 331 of the main conductor 33, the straight conductor 321 and the straight conductor 331 being adjacent to each other, flow in the same direction.

As a result, as illustrated in FIG. 4, the magnetic flux density between the main conductor 31 and the main conductor 32 can be reduced without reducing the magnetic flux density in the inner space of the main conductor 31 and the magnetic flux density in the inner space of the main conductor 32. Similarly, the magnetic flux density between the main conductor 32 and the main conductor 33 can be reduced without reducing the magnetic flux density in the inner space of the main conductor 32 and the magnetic flux density in the inner space of the main conductor 33.

In this way, the magnetic fluxes created by adjacent winding conductors (main conductors) cancel each other out, and this allows the cross-sectional area of the magnetic core between adjacent winding conductors (main conductors) to be reduced and the spacing between the winding conductors (main conductors) to be reduced. Therefore, the array inductor 10 can be reduced in size compared to when a plurality of inductors are individually constructed and disposed. This also enables the switching power supply system module 90 to be reduced in size.

Furthermore, reducing the switching power supply system module 90 in size results in the heat sources (mainly the power semiconductor ICs 931 to 933) being more densely concentrated due to the reduction in volume, and the cooling structure of the switching power supply system module 90 can be simplified.

Furthermore, due to magnetic fluxes being cancelled out between adjacent winding conductors (main conductors) and magnetic coupling between individual winding conductors (main conductors) being suppressed, adverse effects such as reduced power efficiency due to interactions between winding conductors (main conductors) can be reduced in the switching power supply system module 90.

Furthermore, in the above-described configuration, the width d1 of the inner spaces of the winding conductors (main conductors) in the array inductor 10 is made larger than the adjacent distance d2 between adjacent winding conductors (main conductors). By adopting such a configuration for the switching power supply system module 90 as described above, the magnetic flux generated in the main conductors 31, 32, and 33 can be increased, and the interaction between the main conductors 31 and 32 and the interaction between the main conductors 32 and 33 can be suppressed, while reducing the size of the array inductor 10 and the switching power supply system module 90.

As described above, the switching power supply system module 90 realizes a physical structure that is scalable according to the magnitude of the output current, while making maximum use of the magnetic flux generated by the current flowing through the inductor conductors, and furthermore, suppressing the occurrence of leakage magnetic flux.

### Second Embodiment

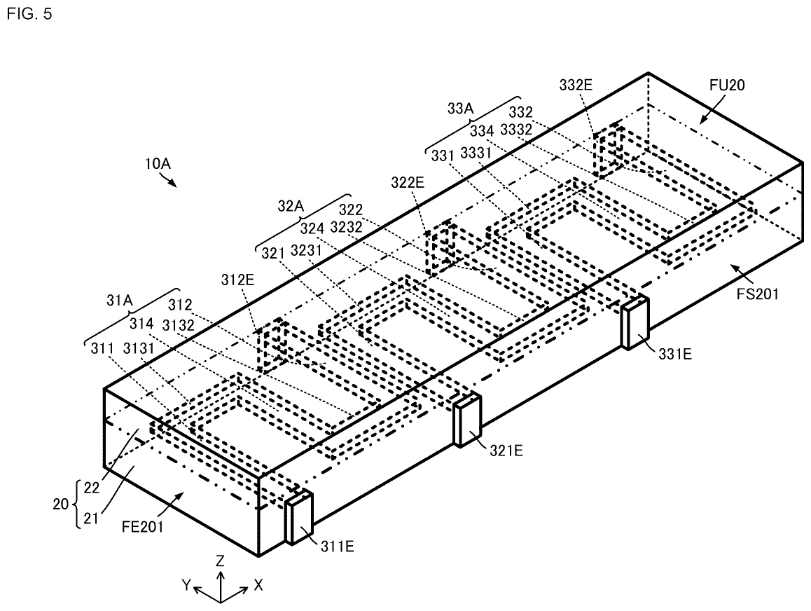

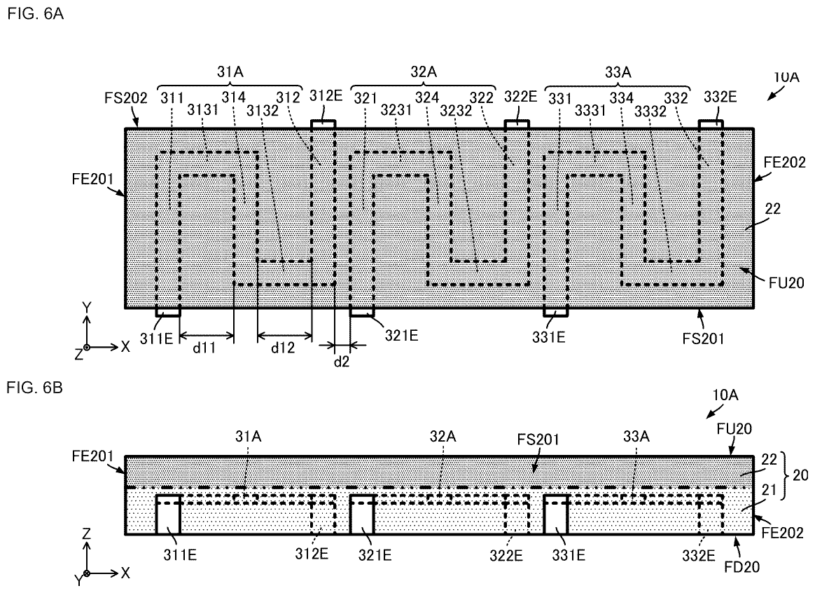

An array inductor according to a Second Embodiment of the present disclosure will be described with reference to the drawings. FIG. 5 is an external perspective view of the array inductor according to the Second Embodiment of the present disclosure. FIG. 6A is a plan view of the array inductor according to the Second Embodiment of the present disclosure, and FIG. 6B is a side view of the array inductor.

As illustrated in FIGS. 5, 6A, and 6B, an array inductor 10A according to the Second Embodiment differs from the array inductor 10 according to the First Embodiment in that a plurality of main conductors 31A, 32A, and 33A are configured to have a meandering shape and with respect to the arrangement of the plurality of terminal portions 311E, 312E, 321E, 322E, 331E, and 332E. The rest of the configuration of the array inductor 10A according to the Second Embodiment is substantially the same as that of the array inductor 10 according to the First Embodiment, and the description of similar parts is omitted. The circuit configuration of the switching power supply system module 90 is substantially the same as that of the First Embodiment, and description thereof is omitted.

The array inductor 10A includes the main conductor 31A, the main conductor 32A, and the main conductor 33A. The main conductor 31A, the main conductor 32A, and the main conductor 33A each have a meandering shape.

The main conductor 31A consists of a straight conductor 311, a straight conductor 312, a straight conductor 3131, a straight conductor 3132, and a straight conductor 314.

The straight conductors 311, 312, and 314 are disposed parallel to the Y-axis direction. The straight conductor 314 is disposed between the straight conductors 311 and 312. The straight conductors 311 and 314 are disposed with a distance (width d11 of the inner space) therebetween in the X-axis direction. The straight conductors 314 and 312 are disposed with a distance (width d12 of the inner space) therebetween in the X-axis direction.

One end of the straight conductor 311 in the extension direction is exposed at the fifth surface FS201. One end of the straight conductor 312 in the extension direction is exposed at the sixth surface FS202. The straight conductor 314 is not exposed at the fifth surface FS201 or the sixth surface FS202.

The straight conductors 3131 and 3132 are disposed parallel to the X-axis direction. The straight conductor 3131 connects the other end of the straight conductor 311 (the end closer to the sixth surface FS202) to one end of the straight conductor 314 (the end closer to the sixth surface FS202). The straight conductor 3132 connects the other end of the straight conductor 314 (the end closer to the fifth surface FS201) to the other end of the straight conductor 312 (the end closer to the fifth surface FS201). As a result, the main conductor 31A forms a meandering conductor when viewed in the Z-axis direction.

The terminal portion 311E is connected to one end of the straight conductor 311. The terminal portion 311E is formed on the fifth surface FS201 of the magnetic core 20, and extends to a position that is substantially flush with the first surface FD20. The terminal portion 312E is connected to one end of the straight conductor 312. The terminal portion 312E is formed on the sixth surface FS202 of the magnetic core 20 and extends to a position approximately flush with the first surface FD20.

The terminal portion 311E is the first terminal PI31 illustrated in FIG. 1, and the terminal portion 312E is the second terminal PO31 illustrated in FIG. 1.

The main conductor 32A consists of a straight conductor 321, a straight conductor 322, a straight conductor 3231, a straight conductor 3232, and a straight conductor 324.

The straight conductors 321, 322, and 324 are disposed parallel to the Y-axis direction. The straight conductor 324 is disposed between the straight conductors 321 and 322. The straight conductors 321 and 324 are disposed with a distance (width d11 of the inner space) therebetween in the X-axis direction. The straight conductors 324 and 322 are disposed with a distance (width d12 of the inner space) therebetween in the X-axis direction.

One end of the straight conductor 321 in the extension direction is exposed at the fifth surface FS201. One end of the straight conductor 322 in the extension direction is exposed at the sixth surface FS202. The straight conductor 324 is not exposed at the fifth surface FS201 or the sixth surface FS202.

The straight conductors 3231 and 3232 are disposed parallel to the X-axis direction. The straight conductor 3231 connects the other end of the straight conductor 321 (the end closer to the sixth surface FS202) to one end of the straight conductor 324 (the end closer to the sixth surface FS202). The straight conductor 3232 connects the other end of the straight conductor 324 (the end closer to the fifth surface FS201) to the other end of the straight conductor 322 (the end closer to the fifth surface FS201). As a result, the main conductor 32A forms a meandering conductor when viewed in the Z-axis direction.

The terminal portion 321E is connected to one end of the straight conductor 321. The terminal portion 321E is formed on the fifth surface FS201 of the magnetic core 20, and extends to a position that is substantially flush with the first surface FD20. The terminal portion 322E is connected to one end of the straight conductor 322. The terminal portion 322E is formed on the sixth surface FS202 of the magnetic core 20 and extends to a position approximately flush with the first surface FD20.

The terminal portion 321E is the first terminal PI32 illustrated in FIG. 1, and the terminal portion 322E is the second terminal PO32 illustrated in FIG. 1.

The main conductor 33A consists of a straight conductor 331, a straight conductor 332, a straight conductor 3331, a straight conductor 3332, and a straight conductor 334.

The straight conductors 331, 332, and 334 are disposed parallel to the Y-axis direction. The straight conductor 334 is disposed between the straight conductors 331 and 332. The straight conductors 331 and 334 are disposed with a distance (width d11 of the inner space) therebetween in the X-axis direction. The straight conductors 334 and 332 are disposed with a distance (width d12 of the inner space) therebetween in the X-axis direction.

One end of the straight conductor 331 in the extension direction is exposed at the fifth surface FS201. One end of the straight conductor 332 in the extension direction is exposed at the sixth surface FS202. The straight conductor 334 is not exposed at the fifth surface FS201 or the sixth surface FS202.

The straight conductors 3331 and 3332 are disposed parallel to the X-axis direction. The straight conductor 3331 connects the other end of the straight conductor 331 (the end closer to the sixth surface FS202) to one end of the straight conductor 334 (the end closer to the sixth surface FS202). The straight conductor 3332 connects the other end of the straight conductor 334 (the end closer to the fifth surface FS201) to the other end of the straight conductor 332 (the end closer to the fifth surface FS201). As a result, the main conductor 33A forms a meandering conductor when viewed in the Z-axis direction.

The terminal portion 331E is connected to one end of the straight conductor 331. The terminal portion 331E is formed on the fifth surface FS201 of the magnetic core 20, and extends to a position that is substantially flush with the first surface FD20. The terminal portion 332E is connected to one end of the straight conductor 332. The terminal portion 332E is formed on the sixth surface FS202 of the magnetic core 20 and extends to a position approximately flush with the first surface FD20.

The terminal portion 331E is the first terminal PI33 illustrated in FIG. 1, and the terminal portion 332E is the second terminal PO33 illustrated in FIG. 1.

The main conductor 31A, the main conductor 32A, and the main conductor 33A are disposed inside the first magnetic portion 21 of the magnetic core 20. The positions of the main conductor 31A, the main conductor 32A, and the main conductor 33A in the Z direction are approximately the same.

The main conductor 31A, the main conductor 32A, and the main conductor 33A are disposed in that order from the fifth surface FS201 toward the sixth surface FS202. In this case, in the main conductor 31A, the straight conductor 311 is disposed closer to the fifth surface FS201 than the straight conductor 312. In the main conductor 32A, the straight conductor 321 is disposed closer to the fifth surface FS201 than the straight conductor 322. In the main conductor 33A, the straight conductor 331 is disposed closer to the fifth surface FS201 than the straight conductor 332.

With this configuration, the straight conductor 312 of the main conductor 31A and the straight conductor 321 of the main conductor 32A are disposed adjacent to each other in parallel at an adjacent distance d2. The straight conductor 322 of the main conductor 32A and the straight conductor 331 of the main conductor 33 are disposed adjacent to each other in parallel at the adjacent distance d2.

With this configuration, the array inductor 10A can achieve substantially the same effects as the array inductor 10.

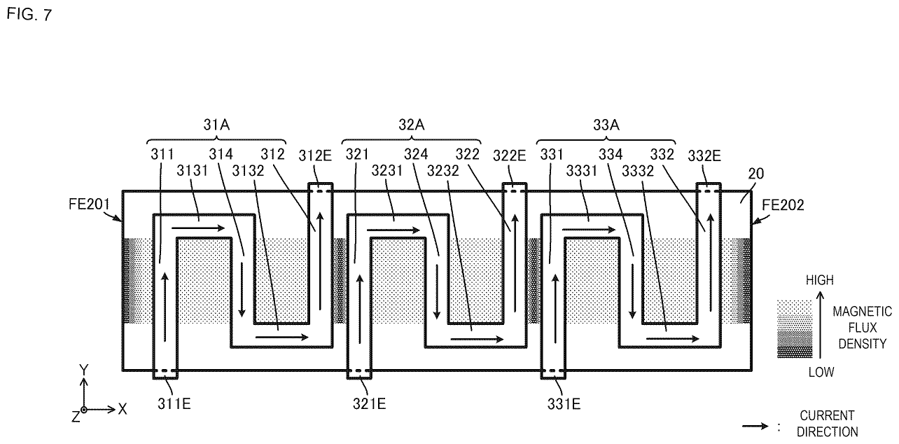

For example, FIG. 7 is a diagram illustrating a current flowing in the array inductor according to the Second Embodiment of the present disclosure and a portion of the magnetic flux generated.

As illustrated in FIG. 7, in the adjacent main conductors 31A and 32A, a first current (switching current) flowing through the straight conductor 312 of the main conductor 31A and a second current (switching current) flowing through the straight conductor 321 of the main conductor 32A, the straight conductor 312 and the straight conductor 321 being adjacent to each other, flow in the same direction. In the adjacent main conductors 32A and 33A, the second current (switching current) flowing through the straight conductor 322 of the main conductor 32A and a third current (switching current) flowing through the straight conductor 331 of the main conductor 33A, the straight conductor 322 and the straight conductor 331 being adjacent to each other, flow in the same direction.

This makes it possible to reduce the magnetic flux density between the main conductor 31A and the main conductor 32A without reducing the magnetic flux density in the inner space of the main conductor 31A and the magnetic flux density in the inner space of the main conductor 32A, as illustrated in FIG. 7. Similarly, it is possible to reduce the magnetic flux density between the main conductor 32A and the main conductor 33A without reducing the magnetic flux density in the inner space of the main conductor 32A and the magnetic flux density in the inner space of the main conductor 33A.

Furthermore, in this configuration, the input terminal and output terminal of each of the main conductors 31A, 32A, and 33A can be disposed on opposite sides of the magnetic core 20.

### Third Embodiment

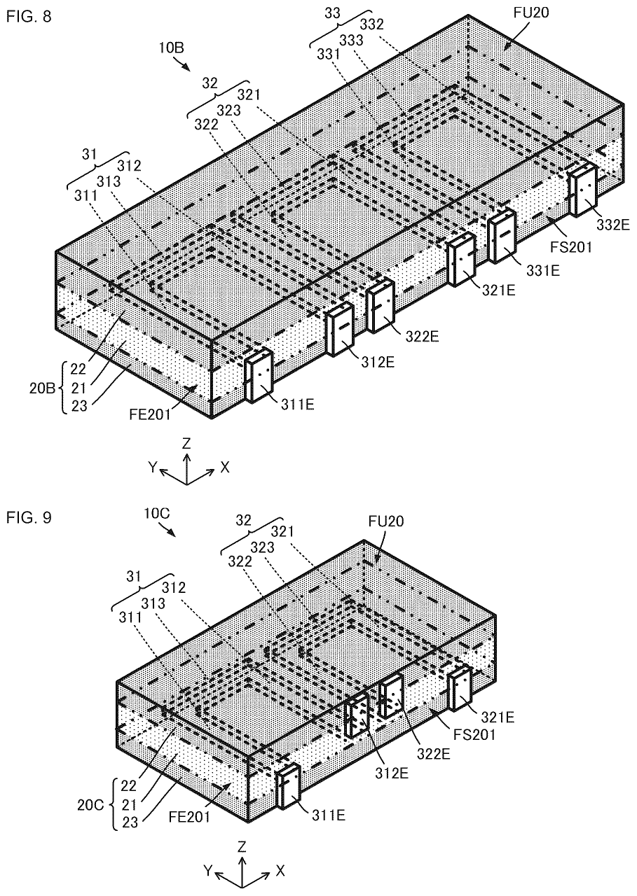

An array inductor according to a Third Embodiment of the present disclosure will be described with reference to the drawings. FIG. 8 is an external perspective view of the array inductor according to the Third Embodiment of the present disclosure.

As illustrated in FIG. 8, an array inductor 10B according to the Third Embodiment differs from the array inductor 10 according to the First Embodiment with respect to the configuration of a magnetic core 20B. The rest of the configuration of the array inductor 10B according to the Third Embodiment is substantially the same as that of the array inductor 10 according to the First Embodiment, and the description of similar parts is omitted. The circuit configuration of the switching power supply system module 90 is substantially the same as that of the First Embodiment, and description thereof is omitted.

The magnetic core 20B includes a first magnetic portion 21, a second magnetic portion 22, and a second magnetic portion 23. The second magnetic portion 22 and the second magnetic portion 23 in this embodiment correspond to a “third magnetic portion” and a “fourth magnetic portion” in the claims.

The second magnetic portion 22 and the second magnetic portion 23 are composed of the same composition.

The second magnetic portion 22 and the second magnetic portion 23 are disposed with the first magnetic portion 21 sandwiched therebetween in the Z-axis direction.

The plurality of main conductors 31, 32, and 33 are enclosed within the first magnetic portion 21.

With this configuration, the array inductor 10B can achieve substantially the same effects as the array inductor 10 according to the First Embodiment.

Furthermore, the array inductor 10B can be further reduced in size, and leakage of magnetic flux to the outside can be further suppressed.

### Fourth Embodiment

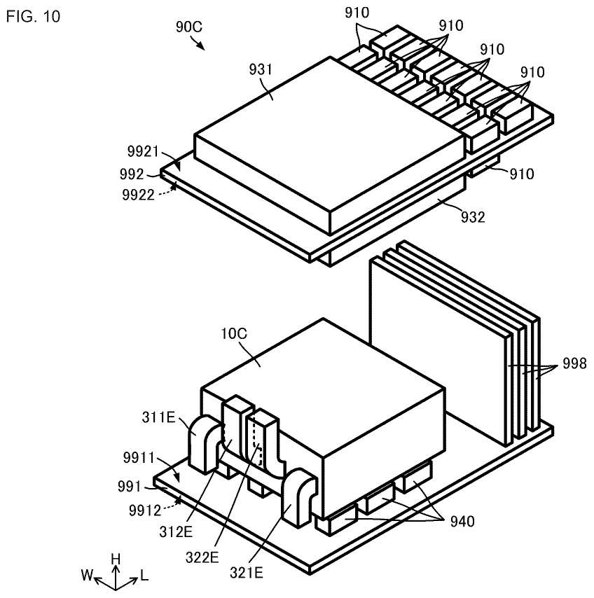

An array inductor according to a Fourth Embodiment of the present disclosure will be described with reference to the drawings. FIG. 9 is an external perspective view of the array inductor according to the Fourth Embodiment of the present disclosure. FIG. 10 is an exploded perspective view of a switching power supply system module according to the Fourth Embodiment of the present disclosure.

As illustrated in FIG. 9, an array inductor 10C according to the Fourth Embodiment differs from the array inductor 10 according to the First Embodiment with respect to the configuration of a magnetic core 20C, the number of inductors, and the configuration of the terminal portions. The rest of the configuration of the array inductor 10C according to the Fourth Embodiment is substantially the same as that of the array inductor 10 according to the First Embodiment, and the description of similar parts is omitted.

As illustrated in FIG. 10, a switching power supply system module 90C according to the Fourth Embodiment differs from the switching power supply system module 90 according to the First Embodiment in terms of the number of power conversion circuits. The rest of the configuration of the switching power supply system module 90C according to the Fourth Embodiment is substantially the same as that of the switching power supply system module 90 according to the First Embodiment, and detailed description thereof is omitted.

As illustrated in FIG. 9, the array inductor 10C includes a magnetic core 20C, a plurality of main conductors 31 and 32, and a plurality of terminal portions 311E, 312E, 321E, and 322E.

The magnetic core 20C includes a first magnetic portion 21 and a plurality of second magnetic portions 22 and 23. The first magnetic portion 21 and the plurality of second magnetic portions 22 and 23 are formed in an integrated manner. The second magnetic portion 22 and the second magnetic portion 23 sandwich the first magnetic portion 21 therebetween in the Z-axis direction. The second magnetic portion 22 forms a second surface FU20 of the magnetic core 20C, and the second magnetic portion 23 forms a first surface FD20 of the magnetic core 20C.

The main conductor 31 and the main conductor 32 consist of winding conductors. The main conductor 31 and the main conductor 32 are enclosed within the first magnetic portion 21. The main conductor 31 and the main conductor 32 are disposed side by side in the X-axis direction.

The terminal portion 311E and the terminal portion 312E are formed on the fifth surface FS201 and connected to the main conductor 31. The terminal portion 311E has a shape that extends to the first surface FD20. The terminal portion 312E has a shape that extends to the second surface FU20.

The terminal portion 321E and the terminal portion 322E are formed on the fifth surface FS201 and connected to the main conductor 32. The terminal portion 321E has a shape that extends to the first surface FD20. The terminal portion 322E has a shape that extends to the second surface FU20.

In this way, the terminal portions connected to both ends of a main conductor may extend in different directions.

As illustrated in FIG. 10, the switching power supply system module 90C includes the array inductor 10C, a circuit board 991, a circuit board 992, a power semiconductor IC 931, a power semiconductor IC 932, a plurality of capacitors 910, a plurality of capacitors 940, and a plurality of connection conductors 998.

The circuit board 991 is board-shaped and has a front surface 9911 and a back surface 9912. The circuit board 991 is mainly composed of an insulating material and has conductor patterns formed thereon and/or therein for realizing the switching power supply system module 90C. The back surface 9912 of the circuit board 991 has conductor patterns formed thereon constituting the input terminals PIH and PIL, and the output terminals POH and POL.

The circuit board 992 is board-shaped and has a front surface 9921 and a back surface 9922. The circuit board 992 is mainly composed of an insulating material, and has conductor patterns formed thereon and/or therein for realizing the switching power supply system module 90C.

The circuit board 991 and the circuit board 992 are disposed with a distance therebetween so that the front surface 9911 of the circuit board 991 and the back surface 9922 of the circuit board 992 face each other.

The plurality of capacitors 910 constitute the input capacitor C91 in FIG. 1. The plurality of capacitors 940 constitute the output capacitor C94 in FIG. 1.

The plurality of connection conductors 998 each consist of a metal plate or an insulating substrate on which a conductor is formed.

The array inductor 10C and the plurality of capacitors 940 are mounted on the front surface 9911 of the circuit board 991. In this case, the array inductor 10C is disposed so as to cover at least a part of the mounting area of the plurality of capacitors 940.

The array inductor 10C is mounted on the front surface 9911 of the circuit board 991 by bonding the terminal portion 311E and the terminal portion 321E to conductor patterns on the front surface 9911 of the circuit board 991.

The power semiconductor IC 931, the power semiconductor IC 932, and the plurality of capacitors 910 are mounted on the circuit board 992. The power semiconductor IC 931 and some of the plurality of capacitors 910 are mounted on the front surface 9921 of the circuit board 992. The power semiconductor IC 932 and the remainder of the plurality of capacitors 910 are mounted on the back surface 9922 of the circuit board 992.

Furthermore, the terminal portion 312E and the terminal portion 322E of the array inductor 10C are connected to the back surface 9922 of the circuit board 992.

The plurality of connection conductors 998 are connected to the front surface 9911 of the circuit board 991 and the back surface 9922 of the circuit board 992.

With this configuration, the switching power supply system module 90C physically forms a circuit that includes two power conversion circuits in the switching power supply system module 90 illustrated in FIG. 1.

In this case, the power semiconductor IC 931, the power semiconductor IC 932, and the array inductor 10C overlap when viewed in the Z-axis direction (in plan view). This allows the switching power supply system module 90C to have a compact shape in plan view. Furthermore, since the array inductor 10C is configured to be compact as described above, the switching power supply system module 90C can also be configured to be even more compact.

In addition, in this configuration, the array inductor 10C also functions as a connection conductor between the circuit board 991 and the circuit board 992. Therefore, the transmission path of a current passing through the array inductor 10C can be shortened, and loss can be suppressed.

This structure also allows the volume of the switching power supply system module 90C to be reduced, and allows heat sources to be more densely concentrated within the volume of the switching power supply system module 90C. This allows the switching power supply system module 90C to be effectively cooled, for example, by installing a heat sink or the like on the top surface of the power semiconductor IC 931. This configuration also allows the cooling structure of the switching power supply system module 90C to be simplified.

### Scalable Structure

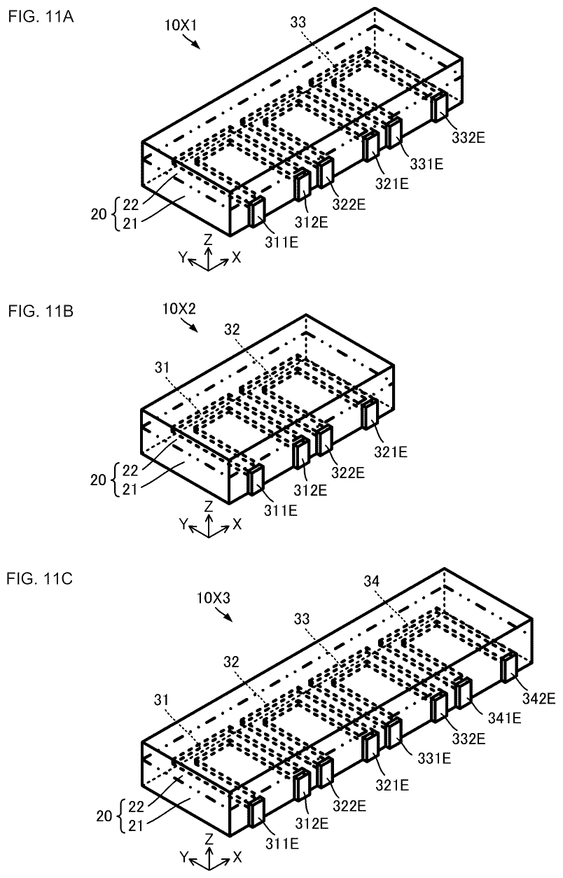

FIGS. 11A, 11B, and 11C are external perspective views of array inductors with different numbers of main conductors (inductors). There are three in FIG. 11A, two in FIG. 11B, and four in FIG. 11C.

As illustrated in FIG. 11A, an array inductor 10X1 includes a magnetic core 20 consisting of a first magnetic portion 21 and a second magnetic portion 22, a plurality of main conductors 31, 32, and 33, and a plurality of terminal portions 311E, 312E, 321E, 322E, 331E, and 332E.

As illustrated in FIG. 11B, an array inductor 10X2 includes a magnetic core 20 consisting of a first magnetic portion 21 and a second magnetic portion 22, a plurality of main conductors 31 and 32, and a plurality of terminal portions 311E, 312E, 321E, and 322E.

As illustrated in FIG. 11C, an array inductor 10X3 includes a magnetic core 20 consisting of a first magnetic portion 21 and a second magnetic portion 22, a plurality of main conductors 31, 32, 33, and 34, and a plurality of terminal portions 311E, 312E, 321E, 322E, 331E, 332E, 341E, and 342E.

As illustrated in FIGS. 11A, 11B, and 11C, the array inductors 10X1, 10X2, and 10X3 differ only in terms of the number of main conductors and terminal portions, and the shapes of the main conductors and the terminal portions are substantially the same. Furthermore, although the dimensions of the magnetic core 20 vary depending on the number of main conductors enclosed therein, the basic shape is the same.

Thus, it is possible to configure a scalable array inductor by adjusting the number of components as appropriate by using the array inductor structure according to the embodiment of the present disclosure. Because the basic structures of the main conductors, terminal portions, and magnetic core are the same, it is possible to shorten the design period for the array inductor and reduce manufacturing costs.

The array inductors illustrated in the above embodiments have been described as including main conductors that are winding conductors or meandering conductors in plan view (viewed in a direction perpendicular to the first surface FD20 and the second surface FU20). However, the main conductors may also be winding conductors or meandering conductors in side view (viewed in a direction parallel to the first surface FD20 and the second surface FU20). In this case, the main conductors only need to be enclosed within the first magnetic portion 21 and disposed so as to not contact with the second magnetic portion 22 or the second magnetic portion 23.

Furthermore, the configurations of the above-described embodiments can be combined as appropriate, and effects can be achieved according to the combinations.
<1> A switching power supply system module comprising a plurality of power conversion circuits, each including a switching element and an inductor; an input capacitor; and an output capacitor. The plurality of inductors included in the plurality of power conversion circuits form an array inductor that is integrally molded using a plurality of inductor conductors and a magnetic core. The magnetic core includes a first magnetic portion and a second magnetic portion composed of different types of magnetic materials. The first magnetic portion is in close contact with and encloses the plurality of inductor conductors. The second magnetic portion is integrated with the first magnetic portion without contacting the plurality of inductor conductors. The plurality of inductor conductors include main conductors that are disposed adjacent to each other with portions of the first magnetic portion interposed therebetween, and are electrically connected to the output capacitor, which is a common output capacitor. Terminal portions connected to ends portions of the main conductors outside the magnetic core and electrically connected to the plurality of switching elements. Accordingly, a multi-phase converter is formed by the plurality of power conversion circuits including the array inductor.
<2> The switching power supply system module according to <1>, wherein the main conductors of the plurality of inductor conductors are winding conductors. In the multi-phase converter, currents flow in opposite directions in the winding conductors that are adjacent to each other, and currents flow in identical directions in adjacent parallel extending portions of the winding conductors. Also, when a current flows through the plurality of winding conductors, magnetic fluxes generated in spaces where the plurality of winding conductors are adjacent to each other in the magnetic core cancel each other out, and magnetic fluxes generated in inner spaces surrounded by the winding conductors in the magnetic core reinforce each other.
<3> The switching power supply system module according to <1> or <2>, wherein the first magnetic portion and the second magnetic portion are each formed by covering surfaces of a powdered magnetic material with an insulating film and using a binder so that compositions of different components come to have an integrally molded structure formed by thermal molding.
<4> The switching power supply system module according to any one of <1> to <3>, wherein the second magnetic portion includes a third magnetic portion and a fourth magnetic portion. The main conductors of the plurality of inductor conductors are disposed side by side in a first direction while enclosed within the first magnetic portion, and the third magnetic portion and the fourth magnetic portion sandwich the first magnetic portion therebetween from both sides in a second direction perpendicular to the first direction.
<5> The switching power supply system module according to any one of <1> to <4>, wherein a relative permeability of the first magnetic portion is smaller than a relative permeability of the second magnetic portion.
<6> The switching power supply system module according to <3>, wherein the first magnetic portion and the second magnetic portion are composed of a metal alloy magnetic material.
<7> The switching power supply system module according to <3>, wherein the magnetic material is composed of a metal magnetic material.
<8> The switching power supply system module according to <2>, wherein a distance between the plurality of winding conductors adjacent to each other is less than or equal to a width of inner spaces surrounded by the winding conductors.
<9> The switching power supply system module according to any one of <1> to <8>, wherein the inductor conductors are line-shaped conductors or strip-shaped conductors that are formed in advance separately from the magnetic core.
<10> The switching power supply system module according to any one of <1> to <9>, wherein the plurality of inductor conductors each include a meandering-shaped main conductor, and a first terminal portion connected to one end portion of the main conductor and a second terminal portion connected to another end portion of the main conductor as the terminal portions. The magnetic core has a first side surface and a second side surface parallel to a direction in which the plurality of inductor conductors are disposed side by side. The plurality of first terminal portions are disposed on the first side surface. The plurality of second terminal portions are disposed on the second side surface, and the multi-phase converter causes switching currents to flow through the plurality of inductor conductors in identical directions.

What is claimed is:

1. A switching power supply system module comprising:
a plurality of power conversion circuits, each including a switching element and an inductor;
an input capacitor; and
an output capacitor,
wherein
the plurality of inductors included in the plurality of power conversion circuits configure an array inductor that is integrally molded using a plurality of inductor conductors and a magnetic core,
the magnetic core includes a first magnetic portion and a second magnetic portion including different types of magnetic materials,
the first magnetic portion encloses the plurality of inductor conductors,
the second magnetic portion is integrated with the first magnetic portion without contacting the plurality of inductor conductors,
the plurality of inductor conductors include main conductors that are adjacent to each other with portions of the first magnetic portion interposed therebetween, and are electrically connected to the output capacitor, which is a common output capacitor, and
terminal portions connected to ends portions of the main conductors outside the magnetic core and electrically connected to the plurality of switching elements, and
a multi-phase converter is configured by the plurality of power conversion circuits including the array inductor.

2. The switching power supply system module according to claim 1, wherein
the main conductors of the plurality of inductor conductors are winding conductors,
in the multi-phase converter, currents flow in opposite directions in the winding conductors that are adjacent to each other,
currents flow in identical directions in adjacent parallel extending portions of the winding conductors,
when a current flows through the plurality of winding conductors, magnetic fluxes generated in spaces where the plurality of winding conductors are adjacent to each other in the magnetic core cancel each other out, and
magnetic fluxes generated in inner spaces surrounded by the winding conductors in the magnetic core reinforce each other.

3. The switching power supply system module according to claim 1, wherein
the first magnetic portion and the second magnetic portion are each configured by covering surfaces of a powdered magnetic material with an insulating film and using a binder so that compositions of different components have an integrally molded structure configured by thermal molding.

4. The switching power supply system module according to claim 1, wherein
the second magnetic portion includes a third magnetic portion and a fourth magnetic portion,
the main conductors of the plurality of inductor conductors are side by side in a first direction while enclosed within the first magnetic portion, and
the third magnetic portion and the fourth magnetic portion sandwich the first magnetic portion therebetween from both sides in a second direction perpendicular to the first direction.

5. The switching power supply system module according to claim 1, wherein
a relative permeability of the first magnetic portion is smaller than a relative permeability of the second magnetic portion.

6. The switching power supply system module according to claim 3, wherein
the first magnetic portion and the second magnetic portion include a metal alloy magnetic material.

7. The switching power supply system module according to claim 3, wherein
the magnetic material includes a metal magnetic material.

8. The switching power supply system module according to claim 2, wherein
a distance between the plurality of winding conductors adjacent to each other is less than or equal to a width of inner spaces surrounded by the winding conductors.

9. The switching power supply system module according to claim 1, wherein
the inductor conductors are line-shaped conductors or strip-shaped conductors that are configured in advance separately from the magnetic core.

10. The switching power supply system module according to claim 1, wherein
the plurality of inductor conductors each includes
a meandering-shaped main conductor, and
a first terminal portion connected to one end portion of the main conductor and a second terminal portion connected to another end portion of the main conductor as the terminal portions,
the magnetic core has a first side surface and a second side surface parallel to a direction in which the plurality of inductor conductors are side by side,
the plurality of first terminal portions are on the first side surface,
the plurality of second terminal portions are on the second side surface, and
the multi-phase converter is configured to cause switching currents to flow through the plurality of inductor conductors in identical directions.

11. The switching power supply system module according to claim 2, wherein
the first magnetic portion and the second magnetic portion are each configured by covering surfaces of a powdered magnetic material with an insulating film and using a binder so that compositions of different components have an integrally molded structure configured by thermal molding.

12. The switching power supply system module according to claim 2, wherein
the second magnetic portion includes a third magnetic portion and a fourth magnetic portion,
the main conductors of the plurality of inductor conductors are side by side in a first direction while enclosed within the first magnetic portion, and
the third magnetic portion and the fourth magnetic portion sandwich the first magnetic portion therebetween from both sides in a second direction perpendicular to the first direction.

13. The switching power supply system module according to claim 3, wherein
the second magnetic portion includes a third magnetic portion and a fourth magnetic portion,
the main conductors of the plurality of inductor conductors are side by side in a first direction while enclosed within the first magnetic portion, and
the third magnetic portion and the fourth magnetic portion sandwich the first magnetic portion therebetween from both sides in a second direction perpendicular to the first direction.

14. The switching power supply system module according to claim 2, wherein
a relative permeability of the first magnetic portion is smaller than a relative permeability of the second magnetic portion.

15. The switching power supply system module according to claim 3, wherein
a relative permeability of the first magnetic portion is smaller than a relative permeability of the second magnetic portion.

16. The switching power supply system module according to claim 4, wherein
a relative permeability of the first magnetic portion is smaller than a relative permeability of the second magnetic portion.

17. The switching power supply system module according to claim 2, wherein
the inductor conductors are line-shaped conductors or strip-shaped conductors that are configured in advance separately from the magnetic core.

18. The switching power supply system module according to claim 3, wherein
the inductor conductors are line-shaped conductors or strip-shaped conductors that are configured in advance separately from the magnetic core.

19. The switching power supply system module according to claim 2, wherein
the plurality of inductor conductors each includes
a meandering-shaped main conductor, and
a first terminal portion connected to one end portion of the main conductor and a second terminal portion connected to another end portion of the main conductor as the terminal portions,
the magnetic core has a first side surface and a second side surface parallel to a direction in which the plurality of inductor conductors are side by side,
the plurality of first terminal portions are on the first side surface,
the plurality of second terminal portions are on the second side surface, and
the multi-phase converter is configured to cause switching currents to flow through the plurality of inductor conductors in identical directions.

20. The switching power supply system module according to claim 3, wherein
the plurality of inductor conductors each includes
a meandering-shaped main conductor, and
a first terminal portion connected to one end portion of the main conductor and a second terminal portion connected to another end portion of the main conductor as the terminal portions,
the magnetic core has a first side surface and a second side surface parallel to a direction in which the plurality of inductor conductors are side by side,
the plurality of first terminal portions are on the first side surface,
the plurality of second terminal portions are on the second side surface, and
the multi-phase converter is configured to cause switching currents to flow through the plurality of inductor conductors in identical directions.
